(19) United States
(12) Patent Application Publication
(10) Pub. No.: US 2019/0017524 A1
(43) Pub. Date: Jan. 17, 2019

(54) VALVE SYSTEM FOR A FLUID CONDUIT SYSTEM IN AN AIRCRAFT ENGINE AND METHOD FOR THE OPERATION OF A VALVE SYSTEM FOR A FLUID CONDUIT SYSTEM IN AN AIRCRAFT ENGINE

(71) Applicant: Rolls-Royce Deutschland Ltd & Co KG, Blankenfelde-Mahlow (DE)

(72) Inventor: Stefan FECHNER, Berlin (DE)

(21) Appl. No.: 16/026,323

(22) Filed: Jul. 3, 2018

(30) Foreign Application Priority Data
Jul. 12, 2017 (DE) 10 2017 115 671.2

(51) Int. Cl. F15B 15/28; F16K 37/00; F02C 9/18; F01D 17/08; F16K 1/22

(52) U.S. Cl. CPC F15B 15/2861; F16K 37/0041; F16K 37/0058; F15B 15/2876; F02C 9/18; F01D 17/085; F16K 1/221; F16K 37/0008

(57) ABSTRACT

A valve system for a fluid line system in an aircraft engine, which fluid line system has at least one fluid line wherein the at least one fluid line has at least one check valve, wherein the valve position of an actuator in the at least one check valve is changeable, in particular automatically changeable, in dependence on the pressure ratios in each case acting on the at least one check valve. The valve system has a monitoring means for recording the respective valve position, in particular the open position and/or the closed position of the actuator, in dependence on at least one measurement value, wherein a signal is output in dependence on the recorded valve position. The valve system furthermore has a means for setting a minimum required sealing-air stream. The invention also relates to a valve control method.

This application claims priority to German Application No. 10 2017 115 671.2 filed Jul. 12, 2017, which application is incorporated by reference herein.

### DESCRIPTION

The invention relates to a valve system for a fluid line system in an aircraft engine having the features of claim 1, and to a method for operating a valve system for a fluid line system in an aircraft engine having the features of claim 11.

In an aircraft engine, a multiplicity of fluids (for example hydraulic fluid, oil, air) is conducted through fluid line systems. One example for such a fluid line system is the so-called secondary air system, which comprises all the air guides in the aircraft engine which do not contribute directly to the thrust of the aircraft engine. The secondary air system conducts for example cooling air or sealing air and/or into those regions of the aircraft engine in which the air is required.

Cooling air is typically used for cooling turbine blades, turbine discs and/or the turbine casing (for example during a tip clearance control).

Sealing air serves for example for the fluid dynamic sealing of spaces in the turbine region, for example with respect to the penetration of hot gases.

The object is thus to efficiently conduct or control fluids within the aircraft engine, and to provide fluid line systems which are in particular also robust with respect to failure of a fluid line.

The object is achieved by a valve system having the features of claim 1.

In this case, in the valve system, the valve position of an actuator in the at least one check valve is changeable, in particular automatically changeable, in dependence on the pressure ratios in each case acting on the at least one check valve; and a monitoring means records the respective valve position, in particular an open position and/or a closed position of the actuator, in dependence on at least one measurement value, wherein a signal is output in dependence on the recorded valve position. Through the use of measurement value monitoring, efficient and non-invasive monitoring of the valve positions is possible. It is thus possible, for example, to respond efficiently to possible failure of fluid lines, in particular air lines. A means, for example the monitoring means, is used to achieve a setting of a minimum required sealing-air stream. It is thus possible to prevent the pressure from dropping by too great an extent locally.

In one embodiment, the at least one measurement value is a temperature value, a pressure value and/or a flow speed value. It is in particular also possible for multiple, different measurement values to be used and for correlations between the measurement values to be utilized.

In one embodiment, a sensor, in particular at least one temperature sensor, at least one pressure sensor and/or at least one flow speed sensor, are/is arranged upstream and/or downstream of the at least one check valve.

Also, in one embodiment of the valve system, when processing the measurement values, a difference of the measurement values from given and/or determined reference measurement values is determined by the monitoring means. It is thus not necessary for absolute measurement values to be used for monitoring, but rather suitably scaled values can be used.

Furthermore, it is possible in one embodiment for the signal for the valve position to be able to be indicated in a magnetic, optical, haptic and/or mechanical manner. The signal may be conducted for example via the flight data processing system of the aircraft engine, with the result that a corresponding valve position is able to be indicated in the maintenance recorder or also in the cockpit.

Embodiments of the valve system may have at least one check valve with a double flap, a rotary flap and/or a ball as an actuator for the fluid. Said actuators allow efficient opening and closing of the fluid line to be achieved.

Here, in one embodiment, air, in particular cooling air and/or sealing air, may be the fluid which flows through the fluid line.

Here, in one embodiment, the fluid line may conduct air from a compressor stage to a turbine stage, in particular to a high-pressure turbine of the aircraft engine. High temperatures prevail precisely in the region of the high-pressure turbine, and so an efficient supply of cooling air is expedient. In a further embodiment, the at least one check valve is arranged in the spatial vicinity of a turbine stage.

The object is also achieved by a method for operating a valve system for a fluid line system in an aircraft engine.

In this case, the valve position of an actuator in the at least one check valve is changed, in particular automatically changed, in dependence on the pressure ratios in each case acting on the at least one check valve, and the respective valve position, in particular the open position and/or the closed position of the actuator, is monitored by a monitoring means in dependence on at least one measurement value, wherein a signal is then output in dependence on the recorded valve position and a minimum required sealing-air stream is set.

The measurement value may be for example a temperature value, a pressure value and/or a flow speed value.

Here, it is possible for example for at least one measurement value to be measured upstream and/or downstream of the at least one check valve.

Also, in one embodiment, when processing the measurement values, a difference of the measurement values from given and/or determined reference measurement values can be determined by the monitoring means. Said determination of the difference is a relatively simple measure.

Also, the signal for the valve position may be indicated for example in a magnetic, optical, haptic and/or mechanical manner.

In one embodiment of the method, the fluid is air, in particular cooling air and/or sealing air. Said media are required in aircraft engines.

The invention will be discussed in connection with the exemplary embodiments illustrated in the figures. In the figures:

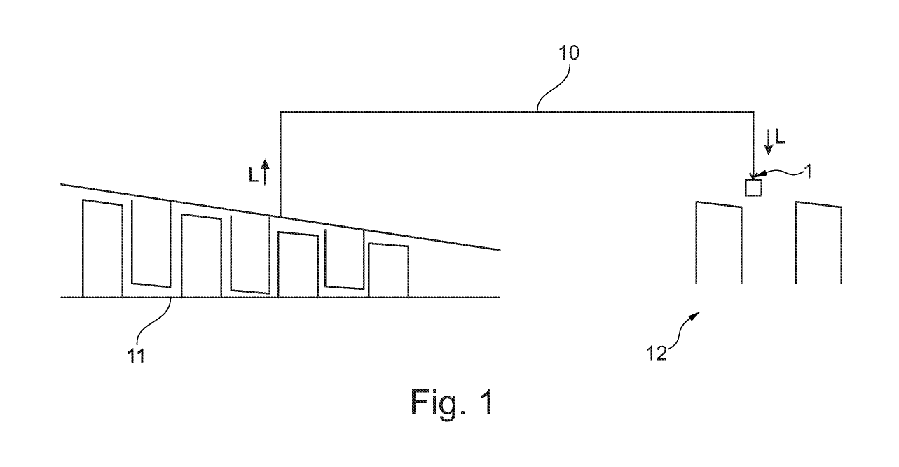

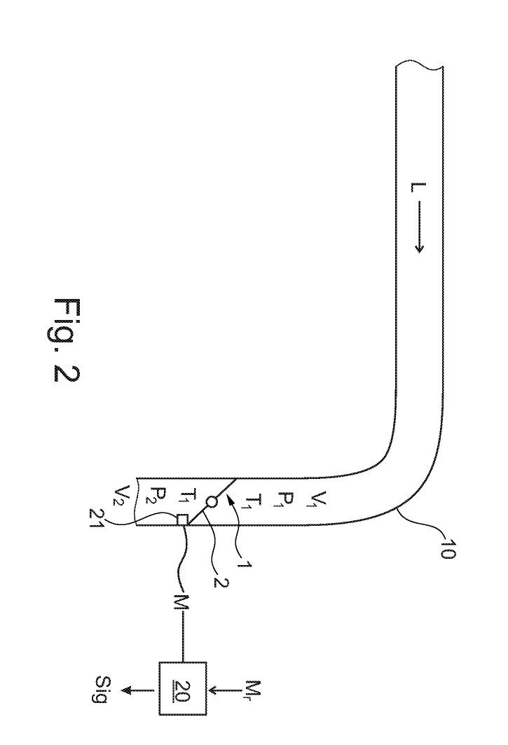

FIG. 1 shows a schematic sectional view through a part of an aircraft engine with a part of a secondary air system;

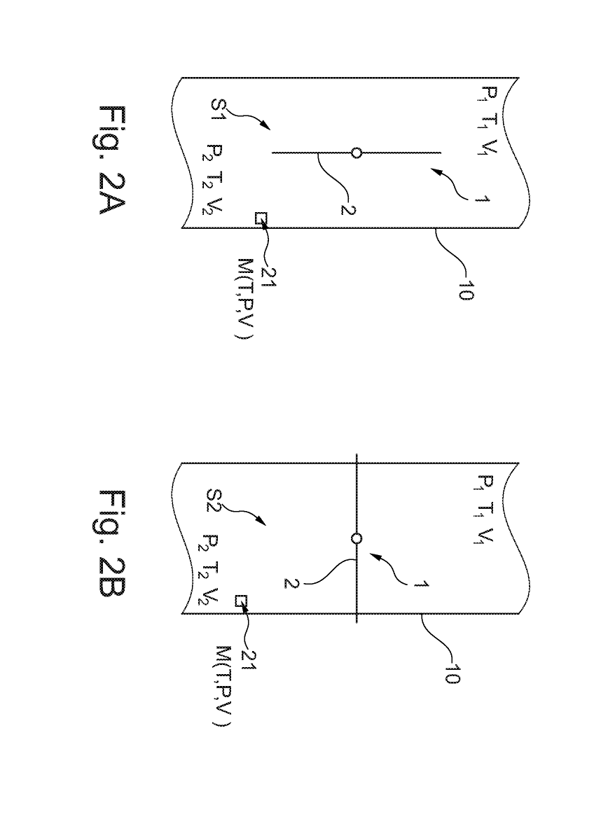

FIG. 2 shows a schematic sectional view of an embodiment of a valve system in the secondary air system with a check valve;

FIG. 2A shows a schematic sectional view of a check valve in an open valve position;

FIG. 2B shows a schematic sectional view of a check valve in a closed valve position.

FIG. 1 partially illustrates a part of an aircraft engine. In the illustrated embodiment, a fluid line 10 is illustrated by way of example, which here conducts an air stream L from a compressor stage 11 to a turbine stage 12. The air stream L is extracted at the compressor stage 11, wherein here the air guide is conducted through the—at least in the side view—substantially U-shaped fluid line 10. The destination of the relatively cool air from the compressor stage 11 is a space around one of the discs of the turbine stage. Here, part of the air stream L is used as cooling air.

Also, part of the air stream L is conducted further into the interior of the aircraft engine, specifically in a space for sealing air. It is thus possible, for example, for bearings to be protected against the entry of hot gases.

Upstream of the entry into the region of the turbine stage 12, specifically upstream of the entry of the air into the space around one of the turbine discs and into the space for sealing air, a check valve 1 is arranged as a part of a valve system.

The illustration in FIG. 1 is to be understood as an example. The aircraft engine may have another design (for example a different number of compressor and/or turbine stages). It is also possible for the fluid line 10 to draw off air at another location, and/or conduct it to another location where it is used for example as cooling air or sealing air. Also, the forms of the fluid lines 10 may be different, in particular it can be more complex, so that, for example, air is discharged from multiple positions in the aircraft engine and/or distributed to multiple positions.

In the embodiment in FIG. 1, the fluid line 10 is in the form of a tube with a circular cross section. In other embodiments, other cross sections (for example polygonal, elliptical) are also possible. It is also possible for the cross section to vary along the flow in the fluid line 10.

In principle, the fluid line may, in another embodiment of the valve system, also conduct liquid media, such as for example hydraulic fluid or oil.

The function of the check valve 1 within the embodiments of the valve system is described more precisely below.

Examples for check valves 1 within the context of the following embodiments are shut-off valves, quick-acting valves, non-return valves or also closure valves, which can allow or prevent a fluid flow, wherein here the check valves 1 are able to be controlled in dependence on pressure ratios prevailing at the check valve 1, in particular automatically.

In FIG. 1, for the sake of simplicity, only one check valve 1 is illustrated at the inlet flange of the turbine casing. In principle, more than one check valve 1 may be used too. It is also possible for one or more check valves to be arranged at other positions in the fluid lines 10.

FIG. 2 illustrates, in a schematic illustration, the structure of an embodiment of a valve system for a fluid line system. In this case, reference may basically be made to respectively relevant parts of the description of FIG. 1.

Here, the fluid line system has a fluid line 10 through which—as in the exemplary embodiment in FIG. 1—air is conducted.

Here, a check valve 1 in the form of a butterfly valve with an actuator 2 is arranged in the fluid line 10. The two valve positions (S1, S2) of the butterfly valve are illustrated in FIGS. 2A and 2B. The check valve 1 is open (S1) in FIG. 2A, and closed (S2) in FIG. 2B.

In alternative embodiments, use is made for example of a non-return valve in the form of a flap instead of the butterfly valve.

Upstream of the check valve 1, the temperature T1, the pressure P1 and the flow speed v1 prevail; downstream, the temperature T2, the pressure P2 and the flow speed v2 prevail. The sensors 21 for said measurement values M, that is to say the pressures, temperatures and/or flow speeds, are not illustrated in FIGS. 2, 2A, 2B.

Here, the valve position S1, S2 of the actuator 2 in the check valve 1 is changeable in dependence on the pressure ratios P1, P2 in each case acting at the check valve 1. If, for example, owing to a break or a leak, a pressure difference (|P1−P2|) of a specific size prevails, then the check valve 1 is automatically closed.

The illustration in FIG. 1 showed that the check valve 1 is situated spatially upstream of the turbine stage 12. The quick closure of the check valve 1 leads to the air (that is to say the cooling air and the sealing air) remaining in the respective regions and not being able to flow back. Cooling and sealing air could then still flow into the spaces in the region of the turbine discs 12 through other fluid lines 10.

If, for example, hot gas were to flow out the fluid line 10 through the leak in the fluid line 10, then the surrounding region of the fluidline 10 would be protected from the hot gas from the spaces in the turbine space.

It is of interest, inter alia for operational safety, to monitor the valve position S1, S2 (open, closed) in a robust manner.

In the illustrated embodiment, use is made of a sensor 21 to measure at least a temperature T, a pressure P and/or a speed v in the fluid line 10 in the vicinity of the check valve 1 (upstream and/or downstream).

Said measured measurement value M (that is to say the absolute value) will be different in each case for the case of a closed and of an open check valve 1, and so monitoring of the valve position S1, S2 is possible.

The measurement values M are transmitted to a monitoring means 20, for example a microcomputer, which is able to process and/or save the measurement values M. The state of the valve position S1, S2 can then be transmitted in the form of a signal Sig to an optical, mechanical, haptic and/or acoustic reproduction device (not illustrated here).

The monitoring of the valve positions S1, S2 may in this case also be realized in dependence on a difference of the measurement values M from a reference measurement value Mr. The reference measurement value Mr may for example be a target value, or an averaged value which has been measured by the monitoring means 20 over a specific period of time. The change in the value can in some cases be recorded more accurately by subtracting a, for example numerically relatively large, target value (that is to say by scaling) (|x−xr|).

The monitoring means 20 may also be used for ensuring the minimum supply of sealing air if a fluid line 10 is closed by the check valve 1 (that is to say a corresponding signal Sig is present). This may be realized for example in that, via other fluid lines, correspondingly more air is delivered into the spaces around the turbine stage.

### LIST OF REFERENCE SIGNS

1 Check valve
2 Actuator
10 Fluid line
11 Compressor stage
12 Turbine stage
20 Monitoring means
L Air stream (fluid stream)
M Measurement value (pressure P, temperature T, flow speed v)
Mr Reference measurement value
P1 Pressure upstream of the check valve
P2 Pressure downstream of the check valve
S1 Open valve position
S2 Closed valve position
Sig Signal in dependence on the valve position

1. A valve system for a fluid line system in an aircraft engine, which fluid line system has at least one fluid line, wherein the at least one fluid line has at least one check valve
wherein
the valve position of an actuator in the at least one check valve is changeable, in particular automatically changeable, in dependence on the pressure ratios in each case acting on the at least one check valve, and
the valve system has the following:
a monitoring means for recording the respective valve position, in particular the open position and/or the closed position of the actuator, in dependence on at least one measurement value, wherein a signal is output in dependence on the recorded valve position, and
a means for setting a minimum required sealing-air stream.

2. The valve system according to claim 1, wherein the measurement value is a temperature value, a pressure value and/or a flow speed value.

3. The valve system according to claim 1, wherein at least one sensor, in particular at least one temperature sensor, at least one pressure sensor and/or at least one flow speed sensor, upstream and/or downstream of the at least one check valve.

4. The valve system according to, wherein, when processing the measurement values, a difference of the measured measurement values from given and/or determined reference measurement values is able to be determined by the monitoring means.

5. The valve system according to claim 1, wherein the signal for the valve position is able to be indicated in a magnetic, optical, haptic and/or mechanical manner.

6. The valve system according to claim 1, wherein the at least one check valve has a double flap, a rotary flap or a ball as an actuator for the fluid.

7. The valve system according to claim 1, wherein the fluid flowing through the check valve is air, in particular cooling air and/or sealing air.

8. (canceled)

9. The valve system according to claim 7, wherein the fluid line conducts air from a compressor stage to a turbine stage, in particular to a high-pressure turbine of the aircraft engine.

10. The valve system according to claim 1, wherein the at least one check valve is arranged in the spatial vicinity of a turbine stage.

11. A method for operating a valve system for a fluid line system in an aircraft engine, which fluid line system has at least one fluid line, wherein the at least one fluid line has at least one check valve,
wherein
a) the valve position of an actuator in the at least one check valve is changed, in particular automatically changed, in dependence on the pressure ratios in each case acting on the at least one check valve,
b) the respective valve position, in particular the open position and the closed position of the actuator, is monitored by a monitoring means in dependence on at least one measurement value (M), wherein
c) a signal is output in dependence on the recorded valve position, and
d) a minimum required seal-air stream is set.

12. The method for operating a valve system according to claim 11, wherein the measurement value is a temperature value, a pressure value and/or a flow speed value.

13. The method for operating a valve system according to claim 11, wherein at least one measurement value is measured upstream and/or downstream of the at least one check valve.

14. The method for operating a valve system according to claim 11, wherein, when processing the measurement values, a difference of the measurement values from given and/or determined reference measurement values is determined by the monitoring means.

15. The method for operating a valve system according to claim 11, wherein the signal for the valve position is indicated in a magnetic, optical, haptic and/or mechanical manner.

16. The method for operating a valve system according to claim 11, wherein the fluid flowing through the check valve is air, in particular cooling air and/or sealing air.

17. (canceled)
